(19) United States
(12) Patent Application Publication
(10) Pub. No.: US 2021/0103275 A1
(43) Pub. Date: Apr. 8, 2021

(54) DATA ANALYZING DEVICE, DATA ANALYZING METHOD, AND ASSOCIATED QUALITY IMPROVEMENT SYSTEM

(71) Applicant: INSTITUTE FOR INFORMATION INDUSTRY, Taipei (TW)

(72) Inventors: Cheng-Juei YU, New Taipei City (TW); Yin-Jing TIEN, Taipei City (TW); Yi-Hsin WU, New Taipei City (TW); Yu-Xuan SU, New Taipei City (TW)

(73) Assignee: INSTITUTE FOR INFORMATION INDUSTRY, Taipei (TW)

(21) Appl. No.: 16/696,529

(22) Filed: Nov. 26, 2019

(30) Foreign Application Priority Data
Oct. 7, 2019 (TW) 108136295

(51) Int. Cl. G05B 19/418

(52) U.S. Cl. CPC G05B 19/41875; G05B 19/4183; G05B 19/4184

(57) ABSTRACT

A data analyzing device, a data analyzing method, and a quality improvement system are provided. The data analyzing device includes a combination generating module, a ratio calculation module, and a weighting calculation module. The data analyzing device performs relevance analysis of to-be-analyzed data associated with a production operation procedure to generate relevance information. The ratio calculation module calculates a ratio parameter according to a total outlier product quantity corresponding to risky combinations in the relevance information and a total product quantity in the to-be-analyzed data. The weighting calculation module calculates a weighting parameter according to a number of the risky combinations in the relevance information and a total number of combinations of production control factors in the to-be-analyzed data. A production equipment selectively adjusts settings of the production operation procedure according to the ratio parameter and the weighting parameter.

This application claims the benefit of Taiwan application Serial No. 108136295, filed Oct. 7, 2019, the subject matter of which is incorporated herein by reference.

### BACKGROUND OF THE INVENTION

### Field of the Invention

The invention relates in general to a data analyzing device, a data analyzing method and an associated quality improvement system, and more particularly to a data analyzing device, a data analyzing method and an associated quality improvement system for improving the yield rate in the production operation procedure.

### Description of the Related Art

Please refer to FIG. 1, which is a schematic diagram illustrating a factory for manufacturing different products. A factory 10 usually manufactures various types of products. For example, different items shown in the diagram represent products A (101), products B (103) products C (105), and products D (107).

In addition to differing in product types, quality management of manufacturing involves five factors, that is, man, machine, material, method, and environment. In the factory 10, these five quality management factors may involve many parameters, and the parameters may further include many options. Any combination of the parameters and the options may affect the yield rates of the products A (101), the products B (103) the products C (105), and the products D (107) produced in the factory 10.

Therefore, to solve the yield problems occurring in the production procedure, tedious and trivial inspection is required. This inspection takes a long time to find out the cause of the problem. It is really a waste of time and effort. However, the inspection is sometimes useless to find the real cause. Therefore, it is an important issue to efficiently find the key point causing the outlier products in order to improve product quality in manufacturing.

### SUMMARY OF THE INVENTION

The invention is directed to a data analyzing device, a data analyzing method, and an associated quality improvement system that analyze outlier data and adjust settings associated with the production operation procedure. The data analyzing device, the data analyzing method, and the associated quality improvement system can improve the yield rate of the production operation procedure.

According to a first aspect of the present invention, a data analyzing device used with a production equipment is provided. The production equipment produces first products during a first production operation procedure. The data analyzing device includes a combination generating module, a ratio calculation module, and a weighting calculation module. The ratio calculation module and the weighting calculation module are in communication with the combination generating module. The combination generating module performs relevance analysis of first to-be-analyzed data associated with the first production operation procedure to generate first relevance information. The ratio calculation module calculates a first ratio parameter according to a total outlier product quantity corresponding to first risky combinations in the first relevance information and a first total product quantity in the first to-be-analyzed data. The first total product quantity is the total quantity of the first products produced by the production equipment during the first production operation procedure. The weighting calculation module calculates a first weighting parameter according to a number of the first risky combinations in the first relevance information and a total number of combinations of first production control factors in the first to-be-analyzed data. The production equipment selectively adjusts settings of the first production operation procedure according to the first ratio parameter and the first weighting parameter.

According to a second aspect of the present invention, a data analyzing method is provided. The data analyzing method is used with a data analyzing device for analyzing a production equipment. The production equipment produces first products during a first production operation procedure. The data analyzing method includes the following steps. A first step is performing a relevance analysis of first to-be-analyzed data associated with the first production operation procedure to generate first relevance information. A further step is calculating a first ratio parameter according to a total outlier product quantity corresponding to first risky combinations in the first relevance information and a first total product quantity in the first to-be-analyzed data. The first total product quantity is the total quantity of the first products produced by the production equipment during the first production operation procedure. A further step is calculating a first weighting parameter according to a number of the first risky combinations in the first relevance information and a total number of combinations of first production control factors in the first to-be-analyzed data. The production equipment selectively adjusts settings of the first production operation procedure according to the first ratio parameter and the first weighting parameter.

According to a third aspect of the present invention, a quality improvement system that includes a data providing device and a data analyzing device in communication with each other is provided. The data providing device includes a procedure monitoring module and a data filtering module. The procedure monitoring module monitors a first production operation procedure used by a production equipment to produce first products and generates first monitoring data. The data filtering module, in communication with the procedure monitoring module, selects first to-be-analyzed data in the first monitoring data according to a first filtering condition. The data analyzing device includes a combination generating module, a ratio calculation module, and a weighting calculation module. The ratio calculation module and the weighting calculation module are in communication with the combination generating module. The combination generating module performs relevance analysis of the first to-be-analyzed data associated with the first production operation procedure to generate first relevance information. The ratio calculation module calculates a first ratio parameter according to a total outlier product quantity corresponding to first risky combinations in the first relevance information and a first total product quantity in the first to-be-analyzed data. The first total product quantity is the total quantity of the first products produced by the production equipment during the first production operation procedure. The weighting calculation module calculates a first weighting parameter according to a number of the first risky combinations in the first relevance information and a total number of combinations of first production control factors in the first to-be-analyzed data. The production equipment selectively adjusts settings of the first production operation procedure according to the first ratio parameter and the first weighting parameter.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram illustrating that a factory in manufacturing for producing various products.

FIG. 2 is a table showing data associated with the production operation procedure.

FIG. 3 is a schematic diagram illustrating a quality improvement system according to an embodiment of the present invention.

FIG. 4 is a schematic diagram illustrating a data providing device according to an embodiment of the present invention.

FIG. 5 is a schematic diagram illustrating a data analyzing device according to an embodiment of the present invention.

FIG. 6 is a flowchart showing that the data analyzing device generates an estimation result according to the to-be-analyzed data.

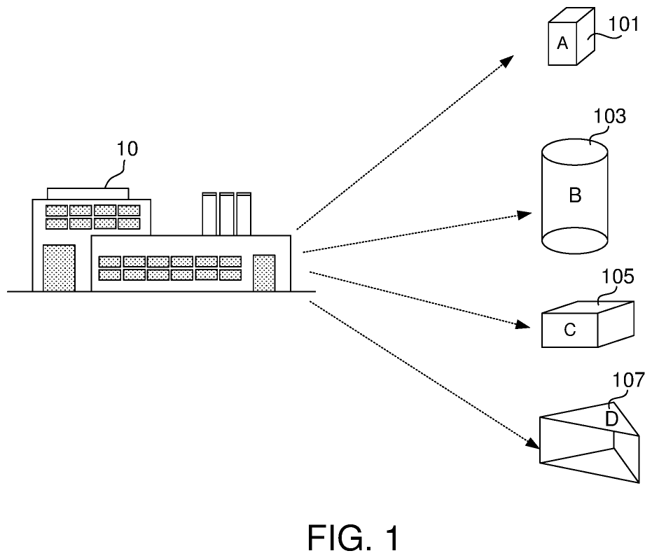

### DETAILED DESCRIPTION OF THE INVENTION

As described above, it is a complicated task in manufacturing to improve the production operation procedure and increase the yield rate. In fact, there are various kinds of factories involving different products and production operation procedures. For example, semiconductors manufacturing at least involves wafer fabrication plants and testing factories. The wafer fabrication plants produce integrated circuits (IC), and the testing factories test the integrated circuits. At first sight, the wafer fabrication plants and the testing factories provide different outputs, and they have differing considerations about quality management of the production operation procedure. However, in view of data analysis, the production operation procedure can be analyzed based on “product” irrespective of wafer fabrication plants, testing factories, or other factories.

Regarding a wafer fabrication plant, the products are integrated circuits, and the production operation procedure is the process for manufacturing the integrated circuits. Regarding a testing factory, the products are testing results of the integrated circuits, and the production operation procedure is the process for testing the integrated circuits. In conventional factories, the production operation procedure varies with the product types. The data analysis method of the present invention can be applied to all of theses factories by considering the relevance between the factors of the production operation procedure and the product quality.

As described above, the quality management of manufacturing involves five factors, that is, man, machine, material, method, and environment. In practice, these five quality management factors involve many parameters, respectively, and the parameters could be set to different values. The quality improvement system only considers the number of the quality factors, but not focuses on respective quality management factors (man, machine, material, method, and environment), the type and the number of the parameters, and the change in the parameter values. The selection or the sequence of the quality factors could be viewed as modification or extension to the present invention and is not specifically described herein.

The production operation procedure used in an integrated circuit testing factory is taken as an example. Only machine factors are considered for illustration purposes. The machine factors to be considered include three types: tester, load board for the integrated circuit, and site of the integrated circuit on the load board. Symbols T, L, and S in the specification represent the tester, the integrated circuit load board, and the site of the integrated circuit on the load board, respectively.

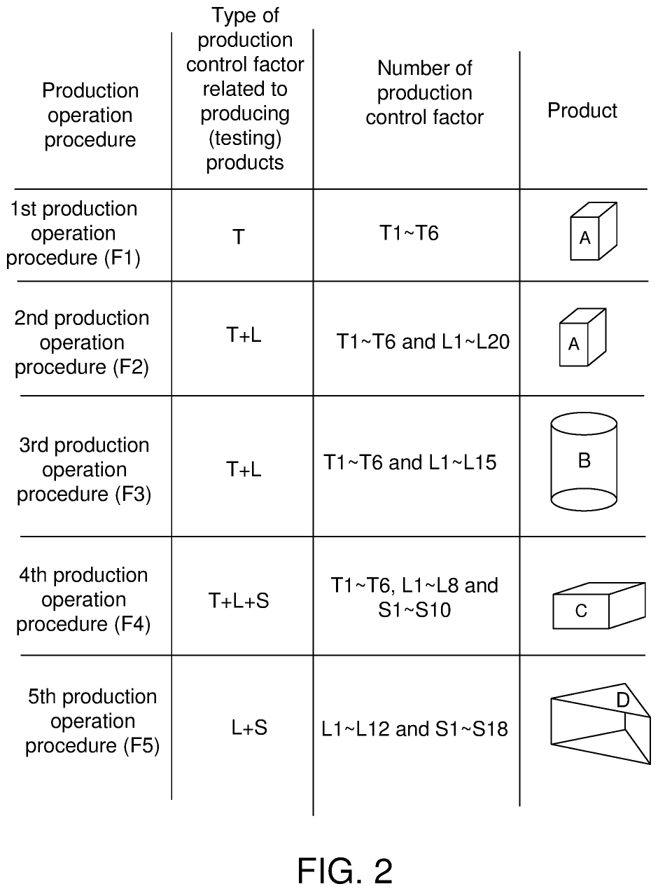

Please refer to FIG. 2, which is a table showing data associated with the production operation procedure. The following description is given based on the table. As shown in the table, it is assumed that the first production operation procedure (F1) is selected to test the products A, the second production operation procedure (F2) is selected to test the products A, the third production operation procedure (F3) is selected to test the products B, the fourth production operation procedure (F4) is selected to test the products C, and the fifth production operation procedure (F5) is selected to test the products D.

Firstly, it is assumed that the first production operation procedure (F1) for testing the products A involves only one type of production control factors, that is, tester (T), wherein six testers (T1˜T6) are used to test the products A. Secondly, it is assumed that the second production operation procedure (F2) for testing the products A involves two types of production control factors, that is, tester (T) and load board (L), wherein six testers (T1˜T6) and twenty load boards (L1˜L20) are used to test the products A. Thirdly, it is assumed that the third production operation procedure (F3) for testing the products B involves two types of production control factors, that is, tester (T) and load board (L), wherein six testers (T1˜T6) and fifteen load boards (L1˜L15) are used to test the products B. Fourthly, it is assumed that the fourth production operation procedure (F4) for testing the products C involves three types of production control factors, that is, tester (T), load board (L) and site (S), wherein six testers (T1˜T6), eight load boards (L1˜L8) and ten sites (S1˜S10) are used to test the products C. Lastly, it is assumed that the fifth production operation procedure (F5) for testing the products D involves two types of production control factors, that is, load board (L) and site (5), wherein twelve load boards (L1˜L12) and eighteen sites (S1˜S18) are used to test the products D.

As described above, one type of production control factors may include multiple production control factors. For example, regarding the tester-related production control factors, each tester corresponds to a production control factor. Therefore, six testers correspond to six production control factors.

Table 1 is a list showing the number of the combinations of production control factors (Xi) and the total product quantity (Yi) associated with the production operation procedure (Fi) based on the data of FIG. 2. The number of combinations of production control factors (Xi) means all possible selection of production control factors, which will affect the product quality of the production operation procedure.

TABLE 1

| Production operation | Number of combinations of | Total product |
|---|---|---|
| procedure (Fi) | production control factors (Xi) | quantity (Yi) |
| 1st production | X1 = 6 | Y1 = 10,000 |
| operation procedure | | |
| (F1) | | |
| 2nd production | X2 = 6*20 = 120 | Y2 = 10,000 |
| operation procedure | | |
| (F2) | | |
| 3rd production | X3 = 6*15 = 90 | Y3 = 8,000 |
| operation procedure | | |
| (F3) | | |
| 4th production | X4 = 6*8*10 = 480 | Y4 = 12,000 |
| operation procedure | | |
| (F4) | | |
| 5th production | X5 = 12*18 = 216 | Y5 = 15,000 |
| operation procedure | | |
| (F5) | | |

As described above, there is only one type of production control factor, that is, tester T, associated with the products A during the first production operation procedure (F1). If there are twenty testers (T1˜T20) installed in the factories, each product A may be tested through any of the six testers (T1˜T6) during the first production operation procedure (F1). Therefore, the number of combinations of production control factors X1 associated with the first production operation procedure (F1) is 6.

Similarly, there are two types of production control factors, that is, tester T and load board L, associated with the products A during the second production operation procedure (F2). If there are twenty testers (T1˜T20) installed in the factories, six of them (T1˜T6) are used to test the products A; and if there are fifty load boards (L1˜L50) set in the factories, twenty of them are used to test the products A. Thus, the products A may be tested through any of the six testers (T1˜T6) with any of the twenty load boards (L1˜L20) during the second production operation procedure (F2). The six testers (T1˜T6) and the twenty load boards (L1˜L20) provide 120 combinations (6*20=120). Therefore, the number of combinations of the production control factors X2 associated with the second production operation procedure (F2) is 120.

Similarly, the number of combinations of production control factors X3 associated with the third production operation procedure (F3) is 90 (6*15=90); the number of combinations of production control factors X4 associated with the fourth production operation procedure (F4) is 480 (6*8*10=480); and the number of combinations of production control factors X5 associated with the fifth production operation procedure (F5) is 216 (12*18=216).

In a real situation, the combinations of the production control factors may vary with possible quality management factors (man, machine, material, method, or environment). It is known that the production operation procedure may be affected by many factors so that the production control factors may contribute hundreds or thousands of combinations. To simplify the description, only the factor “machine” and few production control factors (tester T, load board L, and site S) related to the machine factor are taken into consideration in the specification to explain the concept of the present invention.

The data analysis according to the present invention, involves various types of data and parameters in the calculations. For illustration purposes, these parameters are named different English characters. Furthermore, to identify the parameters used in specific production operation procedure, a variable i (i=1˜5) is added to the end of the characters to indicate the production operation procedure under discussion.

As shown in Table 1, the first production operation procedure (F1) corresponds to 6 combinations (X1) of production control factors, and the factory tests 10,000 products A during the first production operation procedure (F1). The second production operation procedure (F2) corresponds to 120 combinations (X2) of production control factors, and the factory tests 10,000 products A during the second production operation procedure (F2). The third production operation procedure (F3) corresponds to 90 combinations (X3) of production control factors, and the factory tests 8,000 products B during the third production operation procedure (F3). The fourth production operation procedure (F4) corresponds to 480 combinations (X4) of production control factors, and the factory tests 12,000 products C during the fourth production operation procedure (F4). The fifth production operation procedure (F5) corresponds to 216 combinations (X5) of production control factors, and the factory tests 15,000 products D during the fifth production operation procedure (F5).

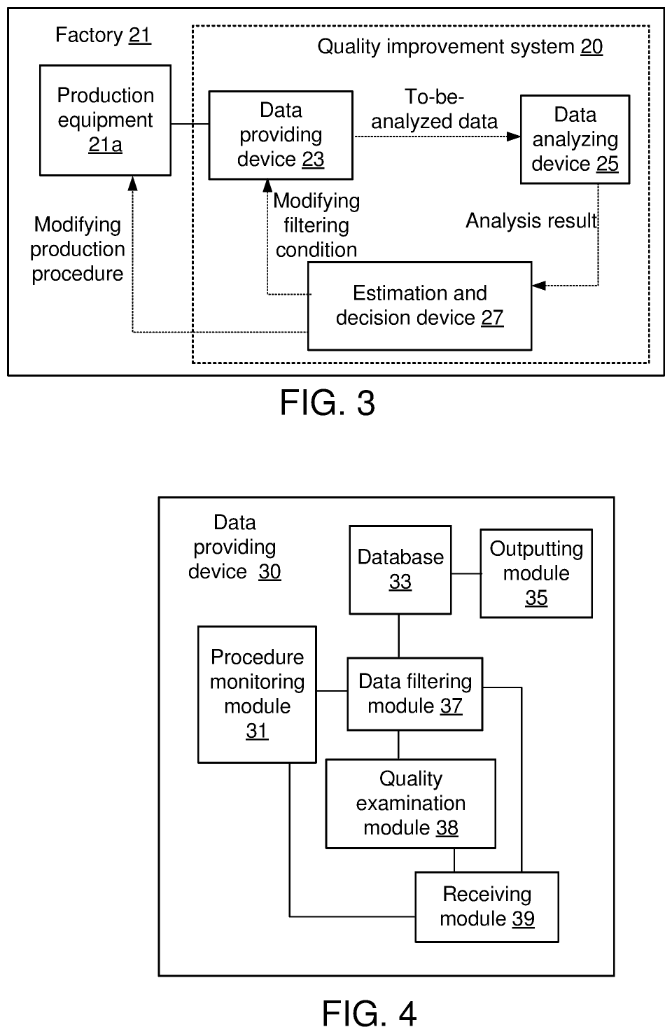

Please refer to FIG. 3, which is a schematic diagram illustrating a quality improvement system according to an embodiment of the present invention. The quality improvement system 20 includes a data providing device 23, a data analyzing device 25, and an estimation and decision device 27. The quality improvement system 20 could be placed in the factory 21. Alternatively, only the data providing device 23 is placed in the factory 21 to detect the status of the production equipment 21a, and the data providing device 23 is in communication with the data analyzing device 25 and the estimation and decision device 27 through any communication method, for example, network or cable line.

Generally speaking, products are produced by the production equipment 21a of the factory 21. The production procedure varies with product types. In a testing factory, the production equipment 21a is a tester. In a wafer fabrication plant, the production equipment 21a is a semiconductor manufacturing machine. Therefore, the production equipment 21a and the production operation procedure are determined according to the products provided by the factory 21.

The data providing device 23 includes several sorts of sensors installed on the production equipment 21a. The data providing device 23 monitors the parameters of the production equipment 21a during the production operation procedure, and then generates to-be-analyzed data according to the sensed parameters. Afterwards, the data providing device 23 transmits the to-be-analyzed data to the data analyzing device 25. After receiving the to-be-analyzed data, the data analyzing device 25 performs the data analyzing method of the present invention to generate an analysis result. Based on the analysis result, it is determined that attention should be paid to which production operation procedure(s) adopted in the factory 21 wherein the corresponding product quality needs improvement. Furthermore, the analysis result can reveal the combination(s) of production control factors, which is likely to cause outlier products corresponding to the determined production operation procedure(s), probably. In the specification, such combinations are called risky combinations of quality factors hereinafter.

The estimation and decision device 27 could be viewed as a data reading platform providing a user interface to be managed by an operator of the production equipment 21a. The operator can modify the settings of the data providing device 23 to decide the form or type of the to-be-analyzed data to be provided. Further, the estimation and decision device 27 could be in communication with the production equipment 21a to modify the production operation procedure of the production equipment 21a through the network. The operation of the estimation and decision device 27 varies with the production operation procedure of the production equipment 21a and the to-be-analyzed data provided by the data providing device 23 in practice and is not discussed herein. Regarding the data providing device 23 and the data analyzing device 25, the associated operation is described in more detail below.

Please refer to FIG. 4, which is a schematic diagram illustrating a data providing device according to an embodiment of the present invention. The data providing device 30 includes a procedure monitoring module 31, a data filtering module 37, a quality examination module 38, a database 33, a receiving module 39 and an outputting module 35. The operation of the data providing device 30 will be described with reference to FIG. 4, and the connection and function of each element are described briefly first.

The procedure monitoring module 31 and the quality examination module 38 are in communication with the production equipment. The data filtering module 37 is in communication with the procedure monitoring module 31, the quality examination module 38, the database 33 and the receiving module 39. The outputting module 35 is in communication with the database 33. The receiving module 39 is in communication with the procedure monitoring module 31, the data filtering module 37, and the quality examination module 38. The outputting module 35 and the receiving module 39 can transfer data to or from the data analyzing device 25 and the estimation and decision device 27 through a cable line or network.

When the production equipment is producing or testing the products, the procedure monitoring module 31 monitors the production equipment and records all associated parameters, for example, testing date, testing period, tester and testing quantity of each tester. The monitoring may go uninterruptedly. Furthermore, the production operation procedure of the production equipment may involve various kinds of production control factors. The procedure monitoring module 31 could be implemented by a single or multiple elements set on the production equipment according to the production operation procedure. Therefore, the procedure monitoring module 31 generates a huge amount of raw data.

To efficiently analyze the data, the data filtering module 37 filters the raw data preliminarily according to a preset filtering condition. The filtering condition may include, for example, selection of products for quality analysis, selection of products produced during a time period (for example, one week or one day), and quantity of products to be analyzed. In practice, the filtering condition could be preset or adjusted according to the settings of the estimation and decision device 27.

After the data filtering module 37 filters the raw data, the filtered data is stored in the database 33 for later analysis. Then, the data analyzing device 25 can read the to-be-analyzed data from database 33 through the outputting module 35 before performing the data analysis. Alternatively, the data filtering module 37 can actively send the to-be-analyzed data to the data analyzing device 25 through the outputting module 35.

The data filtering module 37 selects the to-be-analyzed data according to the filtering condition, and also sends the filtering condition to the quality examination module 38. The quality examination module 38 examines the quality of the products which meet the filtering condition, and determines whether any unsatisfactory product exists among the selected products. For example, the data filtering module 37 determines the production data corresponding to products produced on a specific date as the to-be-analyzed data. Thus, the quality examination module 38 will examine the quality of the products produced on a specific date.

The quality examination module 38 counts the quantity of the unsatisfactory products after examining the quality of the filtered products. In the context of the present specification, the products which do not satisfy the quality standard are defined as outlier products. The quality standard may be a predefined standard or an outlier determined by any know statistical method. For example, whether the products are outlier products or not is determined according to the three sigma rule or multiply the interquartile range (IQR) by the number 1.5. Details about the determination of the outlier products and the calculation of the ratio of the outlier products are not given herein. Table 2 continues the data in Table 1 and shows the ratio Ri (i=1˜5) and the quantity Zi (i=1˜5) of the outlier products.

TABLE 2

| Production operation | Ratio of outlier | Quantity of outlier products |
|---|---|---|
| procedure (Fi) | products (Ri) | (Zi = Yi*Ri) |
| 1st production | R1 = 3% | Z1 = Y1*R1 = |
| operation procedure (F1) | | 10,000*3% = 300 |
| 2nd production | R2 = 3% | Z2 = Y2*R2 = |
| operation procedure (F2) | | 10,000*3% = 300 |
| 3rd production | R3 = 5% | Z3 = Y3*R3 = |
| operation procedure (F3) | | 8,000*5% = 400 |
| 4th production | R4 = 4% | Z4 = Y4*R4 = |
| operation procedure (F4) | | 12,000*4% = 480 |
| 5th production | R5 = 6% | Z5 = Y5*R5 = |
| operation procedure (F5) | | 15,000*6% = 900 |

In the first production operation procedure (F1), the products A produced by the production equipment have an outlier ratio of 3% (R1=3%). The outlier ratio R1 of the products A represents the ratio of the outlier products of the products A corresponding to all of the combinations of production control factors associated with the first production operation procedure (F1) to all of the products A produced during the first production operation procedure (F1). Referring to Table 1 to get the product quantity of the products A (Y1=10,000), it is calculated that 300 outlier products among the products A are produced during the first production operation procedure (F1).

In the second production operation procedure (F2), the products A produced by the production equipment have an outlier ratio of 3% (R2=3%). The outlier ratio R2 of the products A represents the ratio of the outlier products of the products A corresponding to all of the combinations of production control factors associated with the second production operation procedure (F2) to all of the products A produced during the second production operation procedure (F2). Referring to Table 1 to get the product quantity of the products A (Y2=10,000), it is calculated that 300 outlier products among the products A are produced during the second production operation procedure (F2).

In the third production operation procedure (F3), the products B produced by the production equipment have an outlier ratio of 5% (R3=5%). The outlier ratio R3 of the products B represents the ratio of the outlier products of the products B corresponding to all of the combinations of production control factors associated with the third production operation procedure (F3) to all of the products B produced during the third production operation procedure (F3). Referring to Table 1 to get the product quantity of the products B (Y3=8,000), it is calculated that 400 outlier products among the products B are produced during the third production operation procedure (F3).

In the fourth production operation procedure (F4), the products C produced by the production equipment have an outlier ratio of 4% (R4=4%). The outlier ratio R4 of the products C represents the ratio of the outlier products of the products C corresponding to all of the combinations of production control factors associated with the fourth production operation procedure (F4) to all of the products C produced during the fourth production operation procedure (F4). Referring to Table 1 to get the product quantity of the products C (Y4=12,000), it is calculated that 480 outlier products among the products C are produced during the fourth production operation procedure (F4).

In the fifth production operation procedure (F5), the products D produced by the production equipment have an outlier ratio of 6% (R5=6%). The outlier ratio R5 of the products D represents the ratio of the outlier products of the products D corresponding to all of the combinations of production control factors associated with the fifth production operation procedure (F5) to all of the products D produced during the fifth production operation procedure (F5). Referring to Table 1 to get the product quantity of the products D (Y5=15,000), it is calculated that 900 outlier products among the products D are produced during the fifth production operation procedure (F5).

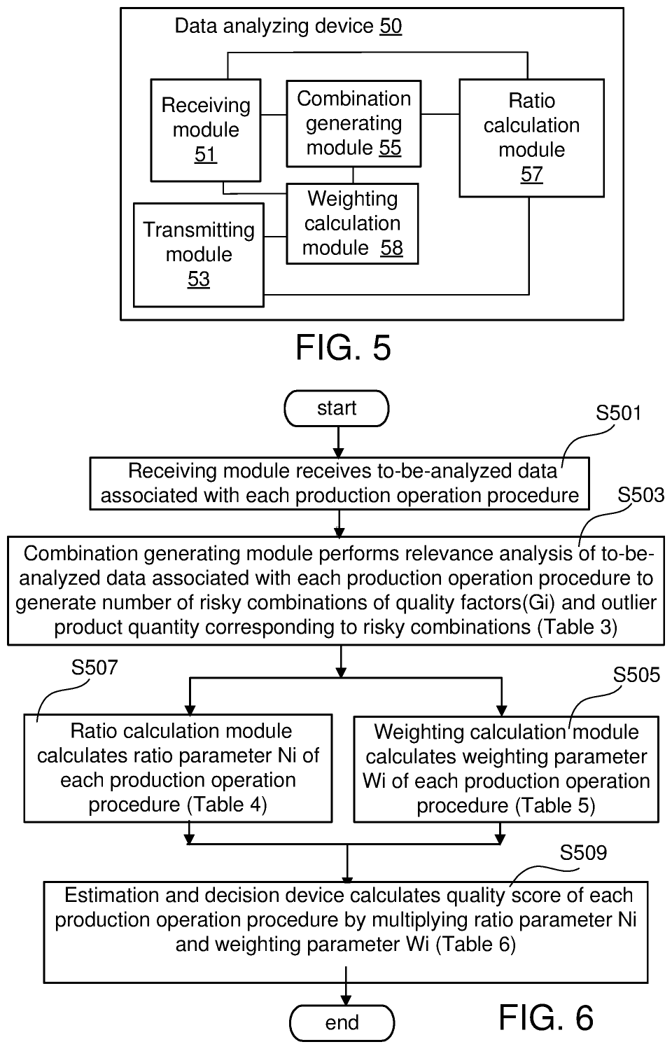

Please refer to FIG. 5, which is a schematic diagram illustrating a data analyzing device according to an embodiment of the present invention. The data analyzing device 50 includes a receiving module 51, a combination generating module 55, a ratio calculation module 57, a weighting calculation module 58 and a transmitting module 53. The receiving module 51 is in communication with the combination generating module 55, the ratio calculation module 57 and the weighting calculation module 58. The receiving module 51 transmits the to-be-analyzed data received from the data providing device to the combination generating module 55, the ratio calculation module 57 and the weighting calculation module 58. Then, the combination generating module 55, the ratio calculation module 57, and the weighting calculation module 58 performs calculation and analysis of the to-be-analyzed data.

The combination generating module 55 is in communication with the ratio calculation module 57 and the weighting calculation module 58. The combination generating module 55 performs relevance analysis of the to-be-analyzed data associated with each production operation procedure F1˜F5, and then sends the analysis result corresponding to each production operation procedure F1˜F5 to the ratio calculation module 57 and the weighting calculation module 58. Subsequently, the ratio calculation module 57 performs ratio calculations, and the weighting calculation module 58 performs weighting calculations.

The transmitting module 53 is in communication with the weighting calculation module 58, the ratio calculation module 57, and the estimation and decision device 27. The transmitting module 53 sends the ratio parameters generated by the ratio calculation module 57 and the weighting parameters generated by the weighting calculation module 58 to the estimation and decision device 27.

Referring back to the example, there are 300 outlier products among the products A corresponding to the 6 combinations of production control factors (testers T1˜T6) associated with the first production operation procedure (F1). It is to be noted that the 300 outlier products are not equally produced by the six testers (T1˜T6) because the six testers (T1˜T6) are not completely identical. Hence, it is not the case that each tester (T1˜T6) produces 50 outlier products.

While each product is produced, the procedure monitoring module 31 records the corresponding combination of production control factors. After one product is judged as an outlier product after the examination, the combination of production control factors corresponding to the outlier product could be identified from the monitoring records. Accordingly, the data analyzing device 50 can analyze the monitoring records and the quality examination results to determine which combinations of production control factors for testing the products probably cause outlier products.

According to the embodiment of the present invention, the combination generating module 55 performs relevance analysis between the outlier products and the production control factors associated with the production operation procedure. At first, all combinations of production control factors for producing the products are generated. Then, any statistical method for variabilities such as three sigma rule or 1.5*IQR can be used to recognize the risky combination of quality factors from the combinations of production control factors. The combination generating module 55 generates a relevance analysis result as shown in Table 3.

Table 3 gives an example of the relevance analysis result generated by the combination generating module 55. The rules of estimating which combinations of production control factors probably cause the outlier products according to the to-be-analyzed data and determining these combinations as risky combinations of quality factors are defined according to the characteristics and requirements of the factory and may vary a lot. Therefore, this example shows how the combination generating module 55 uses the analysis result, but the details about generating the analysis result are not given herein. Further, the respective quantity of the outlier products corresponding to each risky combination of quality factors is called respective outlier product quantity (risky combination) for short.

TABLE 3

| | Number of risky | | Respective outlier |
|---|---|---|---|
| Production | combinations of | Risky | product quantity |
| operation | quality factors | combination of | (risky |
| procedure (Fi) | (Gi) | quality factors | combination) |
| 1st production | G1 = 3 | T1 | 120 |
| operation | | T2 | 90 |
| procedure (F1) | | T3 | 50 |
| 2nd production | G2 = 5 | (T1 + L2) | 90 |
| operation | | (T1 + L3) | 30 |
| procedure (F2) | | (T2 + L3) | 50 |
| | | (T2 + L1) | 20 |
| | | (T3 + L3) | 40 |
| 3rd production | G3 = 4 | (T2 + L11) | 150 |
| operation | | (T6 + L3) | 95 |
| procedure (F3) | | (T5 + L5) | 70 |
| | | (T1 + L9) | 45 |
| 4th production | G4 = 5 | (T1 + L2 + S8) | 120 |
| operation | | (T2 + L3 + S7) | 80 |
| procedure (F4) | | (T1 + L3 + S1) | 50 |
| | | (T2 + L6 + S2) | 40 |
| | | (T6 + L5 + S6) | 20 |
| 5th production | G5 = 6 | (T9 + S2) | 300 |
| operation | | (T5 + S2) | 200 |
| procedure (F5) | | (T2 + S3) | 150 |
| | | (T1 + S1) | 120 |
| | | (T1 + S15) | 60 |
| | | (T7 + S8) | 40 |

According to Table 1, the first production operation procedure (F1) for testing the products A is associated with 6 combinations of production control factors (X1=6). The combination generating module 55 performs the relevance analysis of the 300 outlier products (Z1=300, as shown in Table 2) among the products A to determine that there are three risky combinations of quality factors, that is, testers T1, T2, and T3. The three combinations of production control factors are defined as risky combinations of quality factors associated with the first production operation procedure (F1).

Table 3 further shows the respective quantity of the outlier products among the products A produced under each of the three risky combinations of quality factors during the first production operation procedure (F1). Among the products A tested by the tester T1, the quality examination module 38 determines that 120 products A are outlier products. Among the products A tested by the tester T2, the quality examination module 38 determines that 90 products A are outlier products. Among the products A tested by the tester T3, the quality examination module 38 determines that 50 products A are outlier products. In other words, 120 outlier products are produced under the risky combination of quality factors (T1) during the first production operation procedure (F1); 90 outlier products are produced under the risky combination of quality factors (T2) during the first production operation procedure (F1); and 50 outlier products are produced under the risky combination of quality factors (T3) during the first production operation procedure (F1).

According to Table 1, the second production operation procedure (F2) for testing the products A is associated with 120 combinations of production control factors (X2=120). The combination generating module 55 performs the relevance analysis of the 300 outlier products (Z2=300 as shown in Table 2) among the products A to determine that there are five risky combinations of quality factors, that is, combination of tester T1 and load board L2 (T1+L2), combination of tester T1 and load board L3 (T1+L3), combination of tester T2 and load board L3 (T2+L3), combination of tester T2 and load board L1 (T2+L1) and combination of tester T3 and load board L3 (T3+L3).

Table 3 further shows the respective quantity of the outlier products among the products A under each of the five risky combinations of quality factors during the second production operation procedure (F2). Among the products A tested under the combination of tester T1 and load board L2 (T1+L2), the quality examination module 38 determines that 90 products A are outlier products. Among the products A tested under the combination of tester T1 and load board L3 (T1+L3), the quality examination module 38 determines that 30 products A are outlier products. Among the products A tested under the combination of tester T2 and load board L3 (T2+L3), the quality examination module 38 determines that 50 products A are outlier products. Among the products A tested under the combination of tester T2 and load board L1 (T2+L1), the quality examination module 38 determines that 20 products A are outlier products. Among the products A tested under the combination of tester T3 and load board L3 (T3+L3), the quality examination module 38 determines that 40 products A are outlier products. In other words, 90 outlier products are produced under the risky combination of quality factors (T1+L2) during the second production operation procedure (F2); 30 outlier products are produced under the risky combination of quality factors (T1+L3) during the second production operation procedure (F2); 50 outlier products are produced under the risky combination of quality factors (T2+L3) during the second production operation procedure (F2); 20 outlier products are produced under the risky combination of quality factors (T2+L1) during the second production operation procedure (F2); and 40 outlier products are produced under the risky combination of quality factors (T3+L3) during the second production operation procedure (F2).

According to Table 1, the third production operation procedure (F3) for testing the products B is associated with 90 combinations of production control factors (X3=90). The combination generating module 55 performs the relevance analysis of the 400 outlier products (Z3=400 as shown in Table 2) among the products B to determine that there are four risky combinations of quality factors, that is, combination of tester T2 and load board L11 (T2+L11), combination of tester T6 and load board L3 (T6+L3), combination of tester T5 and load board L5 (T5+L5) and combination of tester T1 and load board L9 (T1+L9).

Table 3 further shows the respective quantity of the outlier products among the products B under each of the four risky combinations of quality factors during the third production operation procedure (F3). Among the products B tested under the combination of tester T2 and load board L11 (T2+L11), the quality examination module 38 determines that 150 products B are outlier products. Among the products B tested under the combination of tester T6 and load board L3 (T6+L3), the quality examination module 38 determines that 95 products B are outlier products. Among the products B tested under the combination of tester T5 and load board L5 (T5+L5), the quality examination module 38 determines that 70 products B are outlier products. Among the products B tested under the combination of tester T1 and load board L9 (T1+L9), the quality examination module 38 determines that 45 products B are outlier products. In other words, 150 outlier products are produced under the risky combination of quality factors (T2+L11) during the third production operation procedure (F3); 95 outlier products are produced under the risky combination of quality factors (T6+L3) during the third production operation procedure (F3); 70 outlier products are produced under the risky combination of quality factors (T5+L5) during the third production operation procedure (F3); and 45 outlier products are produced under the risky combination of quality factors (T1+L9) during the third production operation procedure (F3).

According to Table 1, the fourth production operation procedure (F4) for testing the products C is associated with 480 combinations of production control factors (X4=480). The combination generating module 55 performs the relevance analysis of the 480 outlier products (Z4=480 as shown in Table 2) among the products C to determine that there are five risky combinations of quality factors, that is, combination of tester T1, load board L2 and site S8 (T1+L2+S8), combination of tester T2, load board L3 and site S7 (T2+L3+S7), combination of tester T1, load board L3 and site S1 (T1+L3+S1), combination of tester T2, load board L6 and site S2 (T2+L6+S2) and combination of tester T6, load board L5 and site S6 (T6+L5+S6).

Table 3 further shows the respective quantity of the outlier products among the products C under each of the five risky combinations of quality factors during the fourth production operation procedure (F4). Among the products C tested under the combination of tester T1, load board L2, and site S8 (T1+L2+S8), the quality examination module 38 determines that 120 products C are outlier products. Among the products C tested under the combination of tester T2, load board L3, and site S7 (T2+L3+S7), the quality examination module 38 determines that 80 products C are outlier products. Among the products C tested under the combination of tester T1, load board L3 and site S1 (T1+L3+S1), the quality examination module 38 determines that 50 products C are outlier products. Among the products C tested under the combination of tester T2, load board L6 and site S2 (T2+L6+S2), the quality examination module 38 determines that 40 products C are outlier products. Among the products C tested under the combination of tester T6, load board L5 and site S6 (T6+L5+S6), the quality examination module 38 determines that 20 products C are outlier products. In other words, 120 outlier products are produced under the risky combination of quality factors (T1+L2+S8) during the fourth production operation procedure (F4); 80 outlier products are produced under the risky combination of quality factors (T2+L3+S7) during the fourth production operation procedure (F4); 50 outlier products are produced under the risky combination of quality factors (T1+L3+S1) during the fourth production operation procedure (F4); 40 outlier products are produced under the risky combination of quality factors (T2+L6+S2) during the fourth production operation procedure (F4); and 20 outlier products are produced under the risky combination of quality factors (T6+L5+S6) during the fourth production operation procedure (F4).

According to Table 1, the fifth production operation procedure (F5) for testing the products D is associated with 216 combinations of production control factors (X5=216). The combination generating module 55 performs the relevance analysis of the 900 outlier products (Z5=900 as shown in Table 2) among the products D to determine that there are six risky combinations of quality factors, that is, combination of tester T9 and site S2 (T9+S2), combination of tester T5 and site S2 (T5+S2), combination of tester T2 and site S3 (T2+S3), combination of tester T1 and site S1 (T1+S1), combination of tester T1 and site S15 (T1+S15), and combination of tester T7 and site S8 (T7+S8).

Table 3 further shows the respective quantity of the outlier products among the products D under each of the six risky combinations of quality factors during the fifth production operation procedure (F5). Among the products D tested under the combination of tester T9 and site S2 (T9+S2), the quality examination module 38 determines that 300 products D are outlier products. Among the products D tested under the combination of tester T5 and site S2 (T5+S2), the quality examination module 38 determines that 200 products D are outlier products. Among the products D tested under the combination of tester T2 and site S3 (T2+S3), the quality examination module 38 determines that 150 products D are outlier products. Among the products D tested under the combination of tester T1 and site S1 (T1+S1), the quality examination module 38 determines that 120 products D are outlier products. Among the products D tested under the combination of tester T1 and site S15 (T1+S15), the quality examination module 38 determines that 60 products D are outlier products. Among the products D tested under the combination of tester T7 and site S8 (T7+S8), the quality examination module 38 determines that 40 products D are outlier products. In other words, 300 outlier products are produced under the risky combination of quality factors (T9+S2) during the fifth production operation procedure (F5); 200 outlier products are produced under the risky combination of quality factors (T5+S2) during the fifth production operation procedure (F5); 150 outlier products are produced under the risky combination of quality factors (T2+S3) during the fifth production operation procedure (F5); 120 outlier products are produced under the risky combination of quality factors (T1+S1) during the fifth production operation procedure (F5); 60 outlier products are produced under the risky combination of quality factors (T1+S15) during the fifth production operation procedure (F5); and 40 outlier products are produced under the risky combination of quality factors (T7+S8) during the fifth production operation procedure (F5).

As descried above, several combinations of production control factors of each production operation procedure are likely to cause outlier produces, and are considered as risky combinations of quality factors. In the specification, the total number of the risky combinations of quality factors associated with each production operation procedure is represented by a symbol Gi.

Therefore, in Table 3, there are three risky combinations of quality factors (G1=3) associated with the first production operation procedure (F1); there are five risky combinations of quality factors (G2=5) associated with the second production operation procedure (F2); there are four risky combinations of quality factors (G3=4) associated with the third production operation procedure (F3); there are five risky combinations of quality factors (G4=5) associated with the fourth production operation procedure (F4); and there are six risky combinations of quality factors (G5=6) associated with the fifth production operation procedure (F5).

Subsequently, the number of risky combinations of quality factors Gi and the quantity of the outlier products produced under the risky combinations of quality factors (respective outlier product quantity (risky combination)) listed in Table 3 are further processed by the ratio calculation module 57 and the weighting calculation module 58. Please refer to Table 4 to realize the operation of the ratio calculation module 57. After receiving the respective outlier product quantities (risky combination) from the combination generating module 55, the ratio calculation module 57 adds the respective outlier product quantities (risky combination) together to obtain the total quantity of the outlier products corresponding to the risky combinations of quality factors Mi (total outlier product quantity (risky combination) for short).

The ratio calculation module 57 further calculates the ratio of the total outlier product quantity (risky combination) Mi to the total product quantity Yi. The ratio Ni calculated by the ratio calculation module 57 means the proportion of the quantity of the outlier products produced under the risky combinations of quality factors in the total number of the products produced during a specific production operation procedure. The ratio Ni (ratio parameter) is called outlier product ratio (risky combination) for short. Table 4 shows the total outlier product quantity (risky combination) Mi and the outlier product ratio (risky combination) Ni obtained from the calculation.

TABLE 4

| Production | | Outlier product ratio |
|---|---|---|
| operation | Total outlier product quantity | (risky combination) |
| procedure (Fi) | (risky combination) (Mi) | Ni = (Mi/Yi)*% |
| 1st production | M1 = 120 + 90 + 50 = 260 | N1 = M1/Y1*% = |
| operation | | 260/10,000*% = 2.6% |
| procedure (F1) | | |
| 2nd production | M2 = 90 + 30 + 50 + 20 + | N2 = M2/Y2*% = |
| operation | 40 = 230 | 230/10,000*% = 2.3% |
| procedure (F2) | | |
| 3rd production | M3 = 150 + 95 + 70 + | N3 = M3/Y3*% = |
| operation | 45 = 360 | 360/8,000*% = 4.5% |
| procedure (F3) | | |
| 4th production | M4 = 120 + 80 + 50 + 40 + | N4 = M4/Y4*% = |
| operation | 20 = 310 | 310/12,000*% = 2.6% |
| procedure (F4) | | |
| Sth production | M5 = 300 + 200 + 150 + 120 + | N5 = M5/Y5*% = |
| operation | 60 + 40 = 870 | 870/15,000*% = 5.8% |
| procedure (F5) | | |

In Table 4, the total outlier product quantity (risky combination) (Mi) represents the total quantity of the outlier products produced under the risky combinations associated with the corresponding production operation procedure (Fi). According to the total outlier product quantity (risky combination) Mi and the total product quantity Yi, the outlier product ratio (risky combination) Ni=(Mi/Yi)*% associated with each production operation procedure can be calculated. The outlier product ratio (risky combination) Ni=(Mi/Yi)*% represents the portion of the total outlier product quantity (risky combination) in all produced products.

According to Table 3, the 300 outlier products among the products A produced during the first production operation procedure (F1) include 120 outlier products produced by the tester T1, 90 outlier products produced by the tester T2, and 50 outlier products produced by the tester T3. Therefore, the testers T1˜T3 collectively produce M1=120+90+50=260 outlier products, while the testers T4˜T6 (that is, non-risky combinations) collectively produce 300−260=40 outlier products. Thus, in Table 4, it is shown that the total outlier product quantity (risky combination) (M1) associated with the first production operation procedure (F1) is 260. Regarding the first production operation procedure (F1), the ratio calculation module 57 calculates the outlier product ratio (risky combination) N1=M1/Y1*%=260/10,000*%=2.6% associated with the first production operation procedure (F1) according to the total outlier product quantity (risky combination) M1 in Table 4 and the total product quantity Y1 in Table 1.

According to Table 3, the 300 outlier products among the products A produced during the second production operation procedure (F2) include 90 outlier products produced under the combination of tester T1 and load board L2 (T1+L2), 30 outlier products produced under the combination of tester T1 and load board L3 (T1+L3), 50 outlier products produced under the combination of tester T2 and load board L3 (T2+L3); 20 outlier products produced under the combination of tester T2 and load board L1 (T2+L1); and 40 outlier products produced under the combination of tester T3 and load board L3 (T3+L3). Thus, in Table 4, it is shown that the total outlier product quantity (risky combination) (M2) associated with the second production operation procedure (F2) is 90+30+50+20+40=230, while the other 120−5=115 combinations of production control factors (that is, non-risky combinations) collectively produce 300−230=70 outlier products. Regarding the second production operation procedure (F2), the ratio calculation module calculates the outlier product ratio (risky combination) N2=M2/Y2*%=230/10,000*%=2.3% associated with the second production operation procedure (F2) according to the total outlier product quantity (risky combination) M2 in Table 4 and the total product quantity Y2 in Table 1.

According to Table 3, the 400 outlier products among the products B produced during the third production operation procedure (F3) include 150 outlier products produced under the combination of tester T2 and load board L11 (T2+L11), 95 outlier products produced under the combination of tester T6 and load board L3 (T6+L3), 70 outlier products produced under the combination of tester T5 and load board L5 (T5+L5); and 45 outlier products produced under the combination of tester T1 and load board L9 (T1+L9). Thus, in Table 4, it is shown that the total outlier product quantity (risky combination) (M3) associated with the third production operation procedure (F3) is 150+95+70+45=360, while the other 90−4=86 combinations of production control factors (that is, non-risky combinations) collectively produce 400−360=40 outlier products. Regarding the third production operation procedure (F3), the ratio calculation module 57 calculates the outlier product ratio (risky combination) N3=M3/Y3=360/8,000=4.5% associated with the third production operation procedure (F3) according to the total outlier product quantity (risky combination) M3 in Table 4 and the total product quantity Y3 in Table 1.

According to Table 3, the 480 outlier products among the products C produced during the fourth production operation procedure (F4) include 120 outlier products produced under the combination of tester T1, load board L2 and site S8 (T1+L2+S8), 80 outlier products produced under the combination of tester T2, load board L3 and site S7 (T2+L3+S7), 50 outlier products produced under the combination of tester T1, load board L3 and site S1 (T1+L3+S1); 40 outlier products produced under the combination of tester T2, load board L6 and site S2 (T2+L6+S2); and 20 outlier products produced under the combination of tester T6, load board L5 and site S6 (T6+L5+S6). Thus, in Table 4, it is shown that the total outlier product quantity (risky combination) (M4) associated with the fourth production operation procedure (F4) is 120+80+50+40+20=310, while the other 480−5=475 combinations of production control factors (that is, non-risky combinations) collectively produce 480−310=170 outlier products. Regarding the fourth production operation procedure (F4), the ratio calculation module 57 calculates the outlier product ratio (risky combination) N4=M4/Y4*%=310/12,000*%=2.6% associated with the fourth production operation procedure (F4) according to the total outlier product quantity (risky combination) M4 in Table 4 and the total product quantity Y4 in Table 1.

According to Table 3, the 900 outlier products among the products D produced during the fifth production operation procedure (F5) include 300 outlier products produced under the combination of tester T9 and site S2 (T9+S2), 200 outlier products produced under the combination of tester T5 and site S2 (T5+S2), 150 outlier products produced under the combination of tester T2 and site S3 (T2+S3); 120 outlier products produced under the combination of tester T1 and site S1 (T1+S1); 60 outlier products produced under the combination of tester T1 and site S15 (T1+S15); and 40 outlier products produced under the combination of tester T7 and site S8 (T7+S8). Thus, in Table 4, it is shown that the total outlier product quantity (risky combination) (M5) associated with the fifth production operation procedure (F5) is 300+200+150+120+60+40=870, while the other 216−6=210 combinations of production control factors (that is, non-risky combinations) collectively produce 900−870=30 outlier products. Regarding the fifth production operation procedure (F5), the ratio calculation module 57 calculates the outlier product ratio (risky combination) N5=M5/Y5*%=870/15,000*%=5.8% associated with the fifth production operation procedure (F5) according to the total outlier product quantity (risky combination) M5 in Table 4 and the total product quantity Y5 in Table 1.

After calculating the outlier product ratio (risky combination) of each production operation procedure (F1˜F5), the level of each outlier product ratio (risky combination) is determined. The level of each outlier product ratio (risky combination) is determined according to the yield rate level of the factory. For example, an average ratio of the outlier product ratios (risky combination) may be taken as the baseline. The outlier product ratio (risky combination) higher than the average ratio is defined as a high level ratio. Otherwise, the outlier product ratio (risky combination) is a low level ratio. For example, the average ratio of the outlier product ratios (risky combination) in Table 4 is 3.56% wherein the outlier product ratios (risky combination) of the first, the second and the fourth production operation procedures (F1, F2, F4) are lower than the average ratio and defined as low level ratios, while the outlier product ratios (risky combination) of the third and the fifth production operation procedures (F3, F5) are higher than the average ratio and defined as high level ratios.

The ratio calculation module 57 sends the outlier product ratios (risky combination) Ni to the estimation and decision device 27 through the transmitting module 53 after calculating the outlier product ratios (risky combination) Ni. Since the weighting calculation module 58 and the ratio calculation module 57 operate independently, the weighting calculation module 58 and the ratio calculation module 57 can perform calculation sequentially or concurrently as desired. Please further refer to Table 5 to realize the operation of the weighting calculation module 58.

For illustration purposes, the ratio of the number of risky combinations of quality factors Gi to the number of combinations of production control factors Xi is defined as a risky combination ratio Ji in the specification. Higher risky combination ratio Ji indicates that the risky combinations of quality factors keep a greater portion of the combinations of production control factors Xi. In other words, among the combinations of the production control factors, a greater portion of the risky combinations of quality factors probably cause outlier products.

Furthermore, a central tendency of risky combinations (K1˜K5) is defined for each production operation procedure (F1˜F5) in the specification. As described, the risky combination ratio Ji indicates the ratio of the number of the risky combinations of quality factors Gi to the number of combinations of production control factors Xi (Ji=Gi/Xi). Thus, the central tendency of risky combinations Ki indicates the ratio of the number of non-risky combinations of quality factors to the number of combinations of production control factors Xi (Ki=1−Ji).

More risky combinations result in higher risky combination ratio Ji and lower central tendency of risky combinations Ki. When there are more risky combinations, more combinations of production control factors are likely to cause outlier products. In other words, the combinations of production control factors which probably cause the outlier products are more dispersed. On the other hand, lower risky combination ratio Ji results in the higher central tendency of risky combinations Ki. It represents fewer risky combinations, and the outlier products are concentrated on fewer risky combinations. Thus, it is considered that the outlier products produced under the risky combinations are more concentrated and highly related. For comparing the central tendency of risky combinations of the production operation procedures (F1˜F5), a central weighting Wi is defined in the specification.

At first, the weighting calculation module 58 calculates each risky combination ratio Ji according to the number of risky combinations of quality factors Gi and the number of combinations of production control factors Xi. Then, the weighting calculation module 58 calculates each central tendency of risky combinations Ki according to the risky combination ratio Ji. From the calculation, it is known that the central tendency of risky combinations Ki can show the dispersion degree of the risky combinations, probably causing the outlier products, among the combinations of production control factors. At last, the weighting calculation module 58 calculates each central weighting Wi (weighting parameter) according to the central tendency of risky combinations Ki. The related calculation and operation of the weighting calculation module 58 are listed in Table 5.

TABLE 5

| | | Central tendency | |
|---|---|---|---|
| Production | Risky | of risky | |
| operation | combination ratio | combinations | Central weighting |
| procedure (Fi) | Ji = (Gi/Xi) | Ki = (1 − Ji) | Wi = 1/Kmax*Ki |
| 1st production | J1 = G1/X1 = | K1 = 1 − J1 = | W1 = K1/Kmax = |
| operation | 3/6 = 0.5 | 0.5 | 0.5/0.99 = 0.51 |
| procedure (F1) | | | |
| 2nd production | J2 = G2/X2 = | K2 = 1 − J2 = | W2 = K2/Kmax = |
| operation | 5/120 = 0.042 | 0.958 | 0.96/0.99 = 0.97 |
| procedure (F2) | | | |
| 3rd production | J3 = G3/X3 = | K3 = 1 − J3 = | W3 = K3/Kmax = |
| operation | 4/90 = 0.044 | 0.96 | 0.96/0.99 = 0.97 |
| procedure (F3) | | | |
| 4th production | J4 = G4/X4 = | K4 = 1 − J4 = | W4 = K4/Kmax = |
| operation | 5/480 = 0.01 | 0.99 | 0.99/0.99 = 1 |
| procedure (F4) | | | |
| 5th production | J5 = G5/X5 = | K5 = 1 − J5 = | W5 = K5/Kmax = |
| operation | 6/216 = 0.03 | 0.97 | 0.97/0.99 = 0.98 |
| procedure (F5) | | | |

The risky combination ratio J1 of the first production operation procedure (F1) is calculated according to the number of risky combinations of quality factors G1 in Table 3 and the number of combinations of production control factors X1 in Table 1 (J1=G1/X1=3/6=0.5). Similarly, the risky combination ratio J2 of the second production operation procedure (F2) is J2=G2/X2=5/120=0.042; the risky combination ratio J3 of the third production operation procedure (F3) is J3=G3/X3=4/90=0.044; the risky combination ratio J4 of the fourth production operation procedure (F4) is J4=G4/X4=5/480=0.01; and the risky combination ratio J5 of the fifth production operation procedure (F5) is J5=G5/X5=6/216=0.03.

Subsequently, each central tendency of risky combinations Ki (i=1˜5) of the production operation procedure (Fi) is calculated according to the risky combination ratio Ji (i=1˜5) of the corresponding production operation procedure (Fi). The central tendency of risky combinations K1 of the first production operation procedure (F1) is K1=1-J1=0.5; the central tendency of risky combinations K2 of the second production operation procedure (F2) is K2=1-J2=0.958; the central tendency of risky combinations K3 of the third production operation procedure (F3) is K3=1-J3=0.96; the central tendency of risky combinations K4 of the fourth production operation procedure (F4) is K4=1-J4=0.99; and the central tendency of risky combinations K5 of the fifth production operation procedure (F5) is K5=1-J5=0.97.

In the specification, the maximum of the central tendencies of risky combinations Ki (1=1˜5) is defined as the maximum central tendency of risky combinations Kmax. The ratio of the central tendency of risky combinations Ki to the maximum central tendency of risky combinations Kmax is defined as the central weighting Wi of the production operation procedure (Fi). According to the definition, the central weighting Wi (i=1˜5) of the production operation procedure (Fi) ranges from 0 to 1. In Table 5, it is shown Kmax=K4=0.99.

As shown in Table 5, the central weighting W1 of the first production operation procedure (F1) is W1=K1/Kmax=0.5/0.99=0.51; the central weighting W2 of the second production operation procedure (F2) is W2=K2/Kmax=0.96/0.99=0.97; the central weighting W3 of the third production operation procedure (F3) is W3=K3/Kmax=0.96/0.99=0.97; the central weighting W4 of the fourth production operation procedure (F4) is W4=K4/Kmax=0.99/0.99=1; and the central weighting W5 of the fifth production operation procedure (F5) is W5=K5/Kmax=0.97/0.99=0.98.

The level of the central weighting Wi could be determined according to the 80/20 rule. For example, if the central weighting Wi is 0.8 or greater, it is determined that the central weighting Wi is at a high level. In Table 5, the central weighting W2 of the second production operation procedure (F2), the central weighting W3 of the third production operation procedure (F3), the central weighting W4 of the fourth production operation procedure (F4) and the central weighting W5 of the fifth production operation procedure (F5) are greater than 0.9. Therefore, the central weightings Wi of these four production operation procedures (F2˜F5) are high central weightings.

Table 6 shows the quality score of each production operation procedure, which is calculated by the estimation and decision device 27 according to the outlier product ratio (risky combination) (Ni) and the central weighting Wi (i=1˜5).

TABLE 6

| Production operation | Quality score |
|---|---|
| procedure (Fi) | Si = Ni*Wi |
| 1st production | S1 = N1*W1 = 2.6%*0.51 = 0.01326 |
| operation procedure (F1) | |
| 2nd production | S2 = N2*W2 = 2.3%*0.97 = 0.02231 |
| operation procedure (F2) | |
| 3rd production | S3 = N3*W3 = 4.5%*0.97 = 0.04365 |
| operation procedure (F3) | |
| 4th production | S4 = N4*W4 = 2.6%*1 = 0.026 |
| operation procedure (F4) | |
| Sth production | S5 = N5*W5 = 5.8%*0.98 = 0.05684 |
| operation procedure (F5) | |

The estimation and decision device 27 calculates the product of the outlier product ratio (risky combination) Ni in Table 4 and the central weighting Wi in Table 5 to obtain the quality score Si=Ni*Wi. The quality score Si is calculated for each production operation procedure (Fi). In this embodiment, the quality score S1 of the first production operation procedure (F1) is S1=N1*W1=2.6%*0.51=0.01326; the quality score S2 of the second production operation procedure (F2) is S2=N2*W2=2.3%*0.97=0.02231; the quality score S3 of the third production operation procedure (F3) is S3=N3*W3=4.5%*0.97=0.04365; the quality score S4 of the fourth production operation procedure (F4) is S4=N4*W4=2.6%*1=0.026; and the quality score S5 of the fifth production operation procedure (F5) is S5=N5*W5=5.8%*0.98=0.05684.

From Table 6, it is shown that the quality score S5 of the fifth production operation procedure (F5) is higher than the quality score S3 of the third production operation procedure (F3); the quality score S3 of the third production operation procedure (F3) is higher than the quality score S4 of the fourth production operation procedure (F4); the quality score S4 of the fourth production operation procedure (F4) is higher than the quality score S2 of the second production operation procedure (F2); and the quality score S2 of the second production operation procedure (F2) is higher than the quality score S1 of the first production operation procedure (F1), that is, S5>S3>S4>S2>S1. The sorting of the quality scores indicates that attention should be paid to the fifth production operation procedure (F5) prior to other production operation procedures (F1˜F4).

According to Table 3, the risky combinations of quality factors associated with the fifth production operation procedure (F5) include (T9+S2), (T5+S2), (T2+S3), (T1+S1), (T1+S15) and (T7+S8). Hence, the user or operator of the production equipment can realize, according to the calculation result generated by the estimation and decision device 27, that the production control factors involved in the risky combinations (T9+S2), (T5+S2), (T2+S3), (T1+S1), (T1+S15) and (T7+S8) should be checked or repaired, that is, the testers (T1, T2, T5, T7 and T9) and the sites (S1, S2, S3, S8 and S15).

Please refer to FIG. 6, which is a flowchart showing that the data analyzing device 50 generates an estimation result according to the to-be-analyzed data. At first, the receiving module 51 receives the to-be-analyzed data associated with each production operation procedure from the data providing device 30 (step S501). Then, the combination generating module 55 performs relevance analysis of the to-be-analyzed data associated with each production operation procedure Fi (i=1˜5) to obtain the number of risky combinations of quality factors Gi and the respective outlier product quantity (risky combination) associated with each production operation procedure Fi (i=1˜5) (step S503).

Subsequently, the ratio calculation module 57 calculates the total outlier product quantity (risky combination) Mi according to the respective outlier product quantity (risky combination). Then, the ratio calculation module 57 further calculates the ratio parameter Ni (i=1˜5) of each production operation procedure Fi (i=1˜5) according to the total outlier product quantity (risky combination) Mi and the total product quantity Yi (i=1˜5) provided in the to-be-analyzed data (step S507).

On the other hand, the weighting calculation module 58 calculates the quality score Si (i=1˜5) of each production operation procedure Fi (i=1˜5) (step S505). The weighting calculation module 58 calculates the central weighting Wi (i=1˜5), as shown in Table 5. The number of risky combinations of quality factors Gi is obtained in the analysis result generated by the combination generating module 55, and the number of combinations of production control factors Xi is directly acquired from the to-be-analyzed data.

At last, the estimation and decision device 27 multiplies the ratio parameter Ni (i=1˜5) and the weighting parameter Wi (i=1˜5) to generate the quality score Si (i=1˜5) (step S509). The higher the quality score Si (i=1˜5) of the i-th production operation procedure is, the higher the tracking priority, the i-th production operation procedure has.

In the above embodiments, few parameters (tester T, load board L, and site S) of machine factors of the quality management are taken as the production control factors to describe the concept of the present invention. The other four types of quality factors of quality management, such as man, material, method, and environment, may be further taken as the production control factors of the present invention without doubt. The data analyzing method can be applied to determine whether the production control factors affect the product quality of the production operation procedure and whether the product quality should be improved. Further, different types of factors which may cause the outlier products could be considered at the same time. For example, the quality improvement system considers two material factors, four machine factors, and three environment factors simultaneously wherein each factor may involve more than one parameter. The quality improvement system can consider any of the parameters of the quality factors (man, machine, material, method, and environment) as a production control factor, as described above.

After the data analyzing device generates the analysis result, the estimation and decision device can modify the operation of the production equipment according to the analysis result. For example, the operator may repair the risky machine, which probably produces outlier products or replace the risky machine with another well-operated machine. Alternatively, the estimation and decision device can modify the filtering condition according to the analysis result, for example, increasing the output frequency of the monitoring data (at a time interval of one minute instead of ten minutes) or monitoring and focusing the risky production control factors specially. In other words, the operator can adjust the settings of the production operation procedure by inspecting, maintaining, replacing the production equipment according to the decision made by the estimation and decision device.

To sum up, the data acquisition and analysis, according to the present invention are performed iteratively to achieve real-time calculation and updating. Thus, the quality improvement system can rapidly and automatically identify risky production control factors. Accordingly, the quality improvement system is advantageous to the manufacturing for trouble shooting and improving the yield rate.

Since manufacturing involves various kinds of factories, for example, factories for manufacturing necessities of life such as clothing or shoes or manufacturing modern goods such as integrated circuits, mobile phones, or notebooks, the diversity of the products and production operation procedures id awesome. By parameterizing the production control factors of the production operation procedures, the diversity can be handled in a similar way. Therefore, the present invention with modification can be applied widely in various factories in manufacturing.

It is to be noted that the logic blocks, modules, circuits, and steps of any method described in the embodiments can be implemented by hardware, software, or combination of both. The wording of “in communication with”, “connected to”, “coupled to”, “electrically connected to” or other similar wording is used to indicate direct or indirect signal exchange (for example, cable signals, wireless electromagnetic signals, and optical signals) to achieve transfer and transmission of signals, data or control information to implement the logic blocks, modules, circuits and steps of the method. The wording in the specification does not limit the real connection type, and all known connection types are encompassed in the scope of the present invention.

While the invention has been described by way of example and in terms of the preferred embodiment(s), it is to be understood that the invention is not limited thereto. On the contrary, it is intended to cover various modifications and similar arrangements and procedures, and the scope of the appended claims, therefore, should be accorded the broadest interpretation so as to encompass all such modifications and similar arrangements and procedures.

What is claimed is:

1. A data analyzing device used with a production equipment which produces first products during a first production operation procedure, the data analyzing device comprising:
a combination generating module for performing relevance analysis of first to-be-analyzed data associated with the first production operation procedure to generate first relevance information;
a ratio calculation module in communication with the combination generating module for calculating a first ratio parameter according to a total outlier product quantity corresponding to first risky combinations in the first relevance information and a first total product quantity in the first to-be-analyzed data wherein the first total product quantity is a total quantity of the first products produced during the first production operation procedure; and
a weighting calculation module in communication with the combination generating module for calculating a first weighting parameter according to a number of the first risky combinations in the first relevance information and a total number of combinations of first production control factors in the first to-be-analyzed data, the production equipment selectively adjusting settings of the first production operation procedure according to the first ratio parameter and the first weighting parameter.

2. The data analyzing device according to claim 1, wherein the production equipment further produces second products during a second production operation procedure, and
the combination generating module performs the relevance analysis of second to-be-analyzed data associated with the second production operation procedure to generate second relevance information;
the ratio calculation module calculates a second ratio parameter according to a total outlier product quantity corresponding to second risky combinations in the second relevance information and a second total product quantity in the second to-be-analyzed data wherein the second total product quantity is a total quantity of the second products produced by the production equipment during the second production operation procedure; and
the weighting calculation module calculates a second weighting parameter according to a number of the second risky combinations in the second relevance information and a total number of combinations of second production control factors in the second to-be-analyzed data, the production equipment selectively adjusting settings of the second production operation procedure according to the second ratio parameter and the second weighting parameter.

3. The data analyzing device according to claim 2, wherein a first quality score is obtained by multiplying the first ratio parameter and the first weighting parameter, and a second quality score is obtained by multiplying the second ratio parameter and the second weighting parameter,
wherein when the first quality score is higher than the second quality score, first production control factors associated with the first production operation procedure are adjusted prior to second production control factors associated with the second production operation procedure, and
when the first quality score is lower than the second quality score, the second production control factors associated with the second production operation procedure are adjusted prior to the first production control factors associated with the first production operation procedure.

4. The data analyzing device according to claim 3, wherein the first production control factors are different from the second production control factors.

5. The data analyzing device according to claim 3, wherein at least one of the first production control factors is the same as one of the second production control factors.

6. The data analyzing device according to claim 1, wherein the combination generating module performs the relevance analysis including determining at least one first risky combination of first production control factors associated with the first production operation procedure according to the first to-be-analyzed data, and calculating the total outlier product quantity corresponding to the at least one first risky combination and the number of the at least one first risky combination.

7. The data analyzing device according to claim 1, wherein first production control factors are related to a quality factor associated with the first production operation procedure.

8. A data analyzing method used with a data analyzing device for analyzing a production equipment which produces first products during a first production operation procedure, the data analyzing method comprising steps of:
performing relevance analysis of first to-be-analyzed data associated with the first production operation procedure to generate first relevance information;
calculating a first ratio parameter according to a total outlier product quantity corresponding to first risky combinations in the first relevance information and a first total product quantity in the first to-be-analyzed data wherein the first total product quantity is a total quantity of the first products produced by the production equipment during the first production operation procedure; and
calculating a first weighting parameter according to a number of the first risky combinations in the first relevance information and a total number of combinations of first production control factors in the first to-be-analyzed data, the production equipment selectively adjusting settings of the first production operation procedure according to the first ratio parameter and the first weighting parameter.

9. The data analyzing method according to claim 8, wherein the production equipment further produces second products during a second production operation procedure, and the data analyzing method further comprises steps of:
performing the relevance analysis of second to-be-analyzed data associated with the second production operation procedure to generate second relevance information;
calculating a second ratio parameter according to a total outlier product quantity corresponding to second risky combinations in the second relevance information and a second total product quantity in the second to-be-analyzed data wherein the second total product quantity is a total quantity of the second products produced by the production equipment during the second production operation procedure; and
calculating a second weighting parameter according to a number of the second risky combinations in the second relevance information and a total number of combinations of second production control factors in the second to-be-analyzed data, the production equipment selectively adjusting settings of the second production operation procedure according to the second ratio parameter and the second weighting parameter.

10. The data analyzing method according to claim 9, further comprising steps of:
calculating a first quality score by multiplying the first ratio parameter and the first weighting parameter; and
calculating a second quality score by multiplying the second ratio parameter and the second weighting parameter,
wherein when the first quality score is higher than the second quality score, first production control factors associated with the first production operation procedure are adjusted prior to second production control factors associated with the second production operation procedure, and
when the first quality score is lower than the second quality score, the second production control factors associated with the second production operation procedure are adjusted prior to the first production control factors associated with the first production operation procedure.

11. The data analyzing method according to claim 10, wherein the first production control factors are different from the second production control factors.

12. The data analyzing method according to claim 10, wherein at least one of the first production control factors is the same as one of the second production control factors.

13. The data analyzing method according to claim 8, wherein the step of performing the relevance analysis of the first to-be-analyzed data associated with the first production operation procedure to generate the first relevance information data comprises steps of:
determining at least one first risky combination of first production control factors associated with the first production operation procedure according to the first to-be-analyzed data; and
calculating the total outlier product quantity corresponding to the at least one first risky combination and the number of the at least one first risky combination.

14. A quality improvement system comprising:
a data providing device, comprising:
a procedure monitoring module for monitoring a first production operation procedure used by a production equipment to produce first products and generating first monitoring data; and
a data filtering module in communication with the procedure monitoring module for selecting first to-be-analyzed data in the first monitoring data according to a first filtering condition; and
a data analyzing device in communication with the data providing device, comprising:
a combination generating module for performing relevance analysis of the first to-be-analyzed data associated with the first production operation procedure to generate first relevance information;
a ratio calculation module in communication with the combination generating module for calculating a first ratio parameter according to a total outlier product quantity corresponding to first risky combinations in the first relevance information and a first total product quantity in the first to-be-analyzed data wherein the first total product quantity is a total quantity of the first products produced by the production equipment during the first production operation procedure; and
a weighting calculation module in communication with the combination generating module for calculating a first weighting parameter according to a number of the first risky combinations in the first relevance information and a total number of combinations of first production control factors in the first to-be-analyzed data, the production equipment selectively adjusting settings of the first production operation procedure according to the first ratio parameter and the first weighting parameter.

15. The quality improvement system according to claim 14, wherein the production equipment further produces second products during a second production operation procedure, and
the combination generating module performs the relevance analysis of second to-be-analyzed data associated with the second production operation procedure to generate second relevance information;
the ratio calculation module calculates a second ratio parameter according to a total outlier product quantity corresponding to second risky combinations in the second relevance information and a second total product quantity in the second to-be-analyzed data wherein the second total product quantity is a total quantity of the second products produced by the production equipment during the second production operation procedure; and
the weighting calculation module calculates a second weighting parameter according to a number of the second risky combinations in the second relevance information and a total number of combinations of second production control factors in the second to-be-analyzed data, the production equipment selectively adjusting settings of the second production operation procedure according to the second ratio parameter and the second weighting parameter.

16. The quality improvement system according to claim 15, further comprising an estimation and decision device for calculating a first quality score by multiplying the first ratio parameter and the first weighting parameter, and calculating a second quality score by multiplying the second ratio parameter and the second weighting parameter,
wherein when the first quality score is higher than the second quality score, first production control factors associated with the first production operation procedure are adjusted prior to second production control factors associated with the second production operation procedure, and
when the first quality score is lower than the second quality score, the second production control factors associated with the second production operation procedure are adjusted prior to the first production control factors associated with the first production operation procedure.

17. The quality improvement system according to claim 16, wherein the first production control factors are different from the second production control factors.

18. The quality improvement system according to claim 16, wherein at least one of the first production control factors is the same as one of the second production control factors.

19. The quality improvement system according to claim 14, wherein the combination generating module performs the relevance analysis including determining at least one first risky combination of first production control factors associated with the first production operation procedure according to the first to-be-analyzed data, and calculating the total outlier product quantity corresponding to the at least one first risky combination and the number of the at least one first risky combination.

20. The quality improvement system according to claim 14, wherein first production control factors are related to a quality factor associated with the first production operation procedure.
